(19) United States
(12) Patent Application Publication
(10) Pub. No.: US 2009/0049459 A1
(43) Pub. Date: Feb. 19, 2009

(54) DYNAMICALLY CONVERTING SYMBOLIC LINKS

(75) Inventors: Roopesh C. Battepati, Sammamish, WA (US); Michael C. Johnson, Bothell, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/838,694

(22) Filed: Aug. 14, 2007

(51) Int. Cl. G06F 3/00

(52) U.S. Cl. 719/331

(57) ABSTRACT

Technologies, systems and methods for converting symbolic links from one file system format to another. In particular, presented are example technologies that operate in conjunction with NTFS file systems and that determine the need and convert NFS symbolic links to be compatible with NTFS.

### BACKGROUND

The advent of computing systems and file systems made it possible to store and access files in a file system operating on a computer. A “hard link” is a reference, or pointer, to physical data (such as a file) on a local storage system or disk. In a typical file system, files are referenced by a hard link. A “file name” is typically associated with the hard link for simplicity in referring to the file. Hard links typically refer only to files in a local file system.

As advances in computing and networking have occurred, it has become increasingly popular to store and access files via networks on remote file storage systems. In some scenarios, references to remote files and the like may be maintained in a local file system. Such a reference is commonly referred to as a “Symbolic Link” (“symlink”, also known as a “soft link”) that may be implemented as a special type of file. Unlike a hard link, a symlink does not point directly to data, but contains a symbolic path that a computing system uses to identify a hard link (or another symlink). Such symlinks can be used to refer to data in remote file systems.

Symlinks generally operate transparently; that is, they generally remain invisible to applications and the like. When a program accesses a file that is a symlink, the file system automatically redirects the access to the target of the symlink such that the program is unaware of the redirection. However, methods do exist to detect symlinks so that applications can find and manipulate them.

The exact format of a symlink may vary depending on the type of file system it is associated with which may make a symlink from one file system incompatible with another file system. For example, if a client machine running New Technology File System (“NTFS”) attempts to access a remote file via a Network File System (“NFS”) symlink, the format of the NFS symlink may be different than that understood by NTFS. Such symlink format incompatibilities can make remote file access in a heterogeneous file system environment unreliable, if not impossible.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present examples provide systems and methods for converting symbolic links from one file system format to another. In particular, presented are example technologies that operate in conjunction with NTFS file systems and that determine the need and convert NFS symlinks to be compatible with NTFS.

Many of the attendant features will be more readily appreciated as the same become better understood by reference to the following detailed description considered in connection with the accompanying drawings.

### DESCRIPTION OF THE DRAWINGS

The present description will be better understood from the following detailed description considered in connection with the accompanying drawings, wherein:

FIG. 1 is a block diagram showing an example Symlink Conversion System (“SCS”) within a simplified computing and networking environment.

FIG. 2 is a block diagram showing an example symlink conversion method.

FIG. 3 is a block diagram showing an example computing environment in which the technologies described herein may be implemented.

Like reference numerals are used to designate like parts in the accompanying drawings.

### DETAILED DESCRIPTION

The detailed description provided below in connection with the accompanying drawings is intended as a description of the present examples and is not intended to represent the only forms in which the present examples may be constructed or utilized. The description sets forth at least some of the functions of the examples and/or the sequence of steps for constructing and operating examples. However, the same or equivalent functions and sequences may be accomplished by different examples.

Although the present examples are described and illustrated herein as being implemented in a computing and networking environment, the environment described is provided as an example and not a limitation. As those skilled in the art will appreciate, the present examples are suitable for application in a variety of different types of computing and networking.

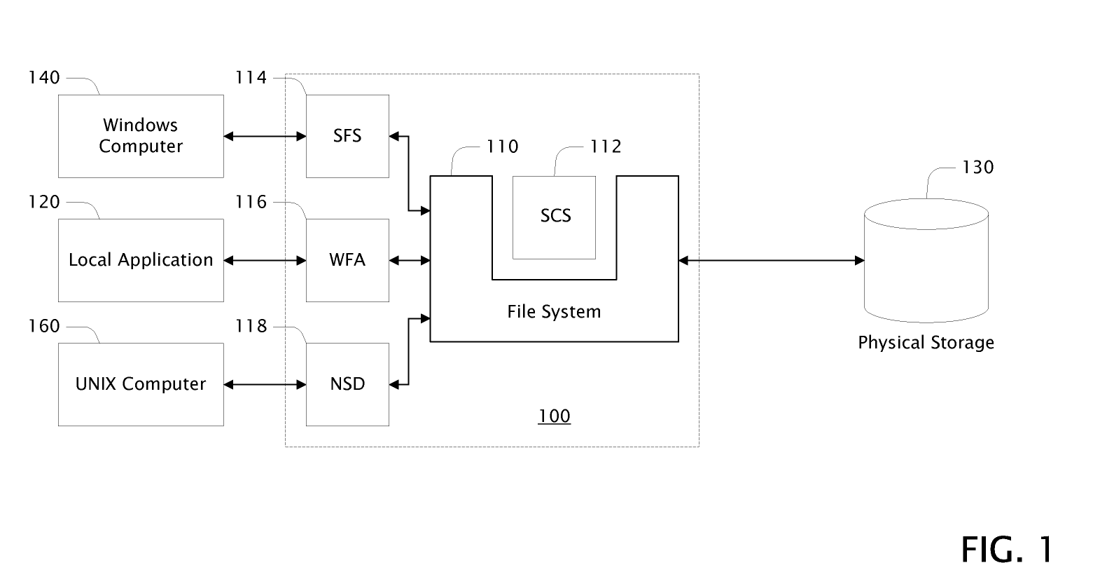

FIG. 1 is a block diagram showing an example Symlink Conversion System (“SCS”) 112 within a simplified computing and networking environment 100. Coupled to file system 110 is example Server Message Block (“SMB”) File Share Service (“SFS”) 114, example local Windows Filesystem Access (“WFA”) 116, and example NFS Server Driver (“NSD”) 1118, any or all of which may be considered separate from or a part of file system 110, and may be a driver, module, service, dynamic link library (“DLL”), or the like. WFA 116 typically provides file system 110 access via an Application Programming Interface (“API”) or the like to local programs, applications, and the like, such as example local application 120. SFS 114 typically provides access via network connectivity to remote computers and the like that make use of the SMB protocol, such as example Windows computer 140. NSD 118 typically provides access via network connectivity to remote computers and that like that make use of the NFS protocol, such as example UNIX computer 160. Entities that access or “call” the file system are known herein as “callers”. A local application that makes use of WFA for file system 110 access, such as local application 120, is known as an “application caller” or a “local caller”. A remote device that makes use of the SMB protocol for file system 110 access, such as Windows computer 140, is known as an “SMB caller”. A remote device that makes use of the NFS protocol for file system 110 access, such as UNIX computer 160, is known as an “NFS caller”.

File system 110 is shown in FIG. 1 coupled to physical storage 130 whereon may be stored data such as file data, symlinks, etc. In one example, storage 130 may be local to file system 110; that is, operating on the same computing device. For example, file system 110 may be NTFS operating on a computer coupled to storage 130, a local hard disk of the computer. Alternatively or additionally, storage 130 may be remote to file system 110; that is, accessible to file system 110 via a network or the like.

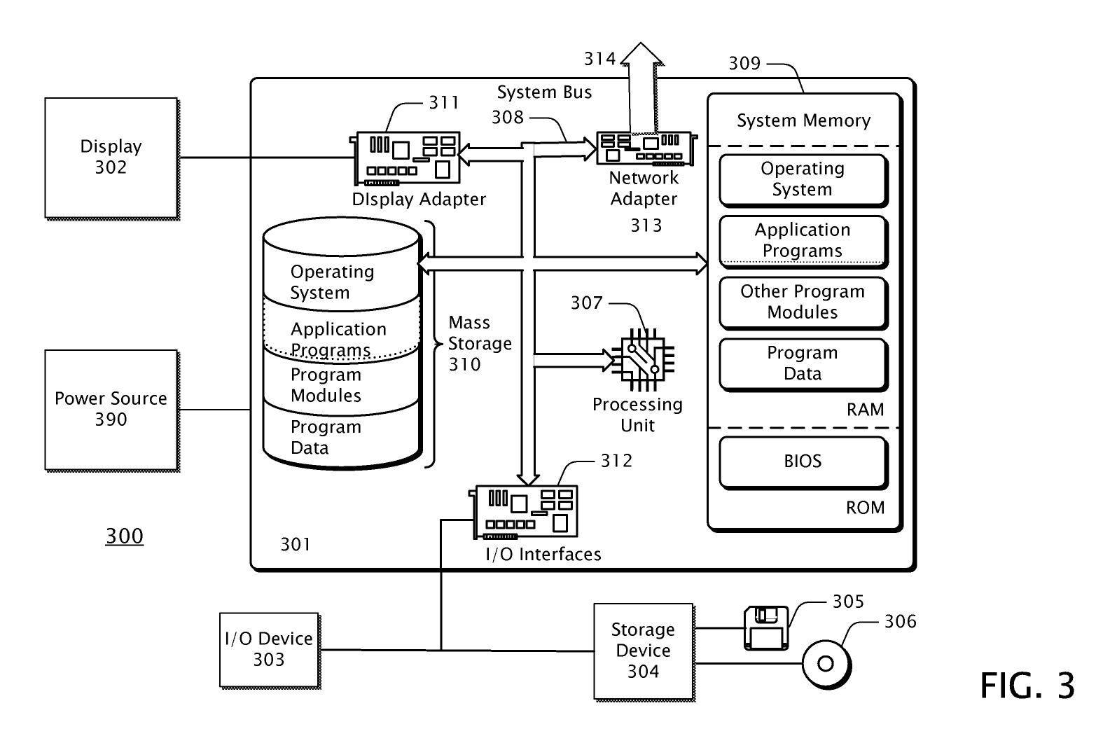

The coupling shown in FIG. 1 between storage 130 and file system 110 may include conventional hardware and/or software interfaces, device drivers, communications links including networks connections and the like, protocols such as NFS, SMB, Common Internet File System (“CIFS”), and the like, and any other such elements. Further, file system 110 may couple with a plurality of local and/or remote storage devices such as physical storage 130. In one example, physical storage device 130 is a conventional mass storage device such as described in connection with FIG. 3.

Symlink Conversion System 112 operates in conjunction with file system 110 to detect and convert symlinks as needed such that they are compatible with file system 110. In one example, SCS 112 is implemented as a file system mini-filter that operates in conjunction with an NTFS file system. In this example, when the NTFS file system retrieves a file, SCS inspects the retrieved file to determine if it is an NFS symlink file. If so, it performs any needed conversion before allowing NTFS to finalize the retrieve operation. The need for conversion is typically dependent on the type of caller application—whether it is an NFS caller or not, and the type of symlink—whether it is an NFS symlink or not.

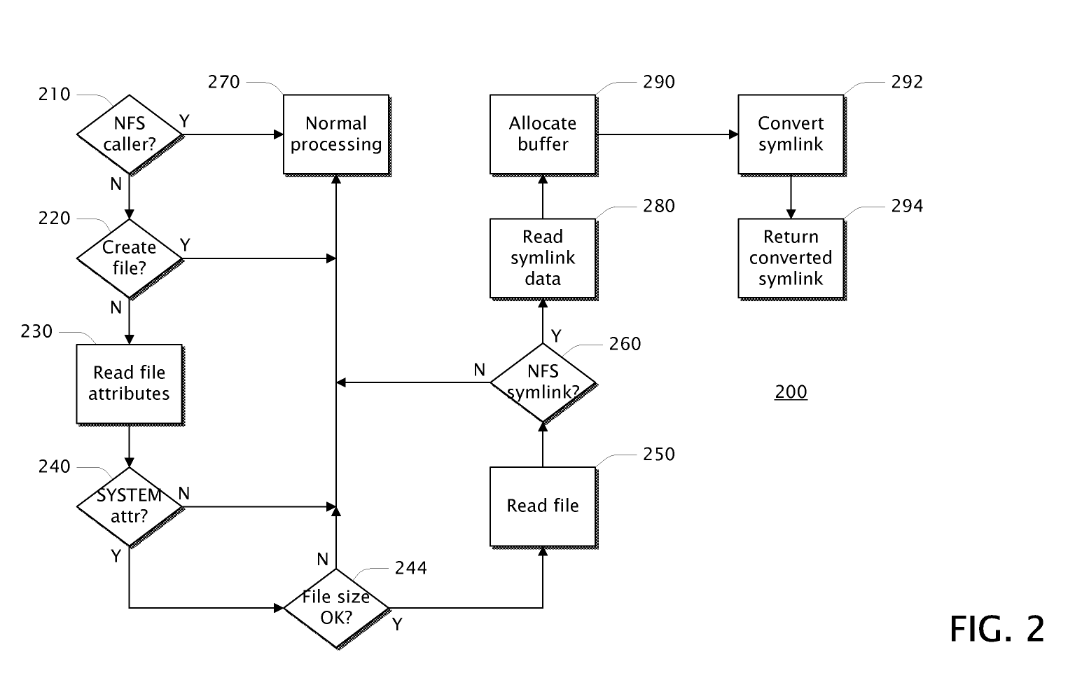

FIG. 2 is a block diagram showing an example symlink conversion method 200. Method 200 is primarily intended for use with NTFS file system where NFS symlinks may be retrieved by the file system for NFS callers and non-NFS callers. Method 200 is typically performed by an SCS in conjunction with an NTFS file system such as described in connection with FIG. 1. Method 200 typically begins at block 210.

Block 210 typically indicates determining if the caller is an NFS caller. If the caller is an NFS caller, method 200 typically continues at block 270. Otherwise, method 200 typically continues at block 220.

Block 220 typically indicates determining is the caller's request is to create a new file as opposed to accessing an assumed existing file (the requested file). An “assumed existing file”, as the term is used herein, is a file that the caller is not attempting to create but is attempting to access. Such an assumed existing file may or may not actually exist and/or be accessible. If the request is to create a new file, method 200 typically continues at block 270. Otherwise, method 200 typically continues at block 230.

Block 230 typically indicates reading the file attributes of the requested file. This step of method 200 typically occurs after the file system obtains the requested file from physical storage. Such physical storage may be local or remote. Once the requested file's attributes are read, method 200 typically continues at block 240.

Block 240 typically indicates determining if the requested file's SYSTEM attribute is set. In one example, this may further include determining if the requested file's HIDDEN attribute is not set. If the SYSTEM attribute is not set (and/or the HIDDEN attribute is not clear), then method 200 typically continues at block 270. Otherwise, method 200 typically continues at block 244.

Block 244 typically indicates determining if the size of the requested file is sufficient to contain an NFS symlink. The file size must be at least as large as the size of a symlink header plus a valid target representation. Additionally, block 244 may also indicate determining if the requested file is too large to be a symlink file. If the requested file is not within the correct size range, method 200 typically continues at block 270. Otherwise, method 200 typically continues at block 250. “ANSI” as used herein is defined as “American National Standards Institute”.

In one example, a symlink header is comprised of a version tag that comprises the first 8 bytes of a symlink file. Valid values for the version tag include the following:

#define NFS_SPECFILE_LNK_V0 0x004b4e4c78696e55
/* “UnixLNK” */
#define NFS_SPECFILE_LNK_V1 0x014b4e4c78746e49
/* “IntxLNK” */

In this example the remainder of the file content following the version tag is typically a UNICODE string representing the target of the symlink. In an alternate example, the symlink header is the ANSI string “NFS Server:SymLink:Path=”. In this example, the remainder of the file content is typically an ANSI string representing the target of the symbolic link. The target is typically a specific file or another symlink.

Block 250 typically indicates reading the data of the requested file. In one example, the reading includes a sufficient number of bytes to retrieve an NFS symbolic link header should the requested file be a symlink file. Once the requested file is read, method 200 typically continues at block 260.

Block 260 indicates determining if the data read from the requested file includes an NFS symlink header. If the requested file does not contain an NFS symlink header, then method 200 typically continues at block 270. Otherwise, method 200 typically continues at block 280.

Block 270 typically indicates the file system continuing with normal processing. This is typically the case when a) the requested file is not an NFS symlink file or does not contain an NFS symlink, and b) no conversion of the symlink is required because the caller is an NFS caller. After block 270, method 200 is typically complete.

Block 280 typically indicates reading the target from the requested file. In one example, the reading is actually parsing the target and other relevant data from the data read at block 250. Once the reading is complete, method 200 typically continues at block 290.

Block 290 typically indicates allocating a buffer into which a converted symlink will be stored. In one example, the buffer is a REPARSE DATA BUFFER structure as shown herein below:

```
typedef struct _REPARSE_DATA_BUFFER {
    ULONG ReparseTag;
    USHORT ReparseDataLength;
    USHORT Reserved;
    union {
        struct {
            USHORT SubstituteNameOffset;
            USHORT SubstituteNameLength;
            USHORT PrintNameOffset;
            USHORT PrintNameLength;
            ULONG Flags;
            WCHAR PathBuffer[1];
        } SymbolicLinkReparseBuffer;
        struct {
            USHORT SubstituteNameOffset;
            USHORT SubstituteNameLength;
            USHORT PrintNameOffset;
            USHORT PrintNameLength;
            WCHAR PathBuffer[1];
        } MountPointReparseBuffer;
        struct {
            UCHAR DataBuffer[1];
        } GenericReparseBuffer;
    } DUMMYUNIONNAME;
} REPARSE_DATA_BUFFER, *PREPARSE_DATA_BUFFER;
```

Once the buffer is allocated, method 200 typically continues at block 292.

Block 292 typically indicates converting the symlink and storing the converted symlink in the allocated buffer. In one example, the symlink is converted from NFS format and stored in a REPARSE DATA BUFFER structure. The converting includes converting UNIX style directory de-limiters ‘/’ to NTFS style ‘\’ as well as filling in necessary fields of the REPARSE DATA BUFFER structure from the NFS symlink data. Once the converting is complete. Method 200 typically continues at block 294.

Block 294 typically indicates returning the converted symlink. In one example, a REPARSE DATA BUFFER structure is returned that has been filled in with the converted symlink. In this example, the structure is returned with a STATUS_REPARSE result code. After block 294, method 200 is typically complete.

FIG. 3 is a block diagram showing an example computing environment 300 in which the technologies described herein may be implemented. A suitable computing environment may be implemented with numerous general purpose or special purpose systems. Examples of well known systems may include, but are not limited to, cell phones, personal digital assistants (“PDA”), personal computers (“PC”), hand-held or laptop devices, microprocessor-based systems, multiprocessor systems, servers, workstations, consumer electronic devices, set-top boxes, and the like.

Computing environment 300 typically includes a general-purpose computing system in the form of a computing device 301 coupled to various components, such as peripheral devices 302, 303, 304 and the like. System 300 may couple to various other components, such as input devices 303, including voice recognition, touch pads, buttons, keyboards and/or pointing devices, such as a mouse or trackball, via one or more input/output (“I/O”) interfaces 312. The components of computing device 301 may include one or more processors (including central processing units (“CPU”), graphics processing units (“GPU”), microprocessors (“μP”), and the like) 307, system memory 309, and a system bus 308 that typically couples the various components. Processor 307 typically processes or executes various computer-executable instructions to control the operation of computing device 301 and to communicate with other electronic and/or computing devices, systems or environment (not shown) via various communications connections such as a network connection 314 or the like. System bus 308 represents any number of several types of bus structures, including a memory bus or memory controller, a peripheral bus, a serial bus, an accelerated graphics port, a processor or local bus using any of a variety of bus architectures, and the like.

System memory 309 may include computer readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 309 typically stores data, computer-executable instructions and/or program modules comprising computer-executable instructions that are immediately accessible to and/or presently operated on by one or more of the processors 307.

Mass storage devices 304 and 310 may be coupled to computing device 301 or incorporated into computing device 301 via coupling to the system bus. Such mass storage devices 304 and 310 may include non-volatile RAM, a magnetic disk drive which reads from and/or writes to a removable, non-volatile magnetic disk (e.g., a “floppy disk”) 305, and/or an optical disk drive that reads from and/or writes to a non-volatile optical disk such as a CD ROM, DVD ROM 306. Alternatively, a mass storage device, such as hard disk 310, may include non-removable storage medium. Other mass storage devices may include memory cards, memory sticks, tape storage devices, and the like.

Any number of computer programs, files, data structures, and the like may be stored in mass storage 310, other storage devices 304, 305, 306 and system memory 309 (typically limited by available space) including, by way of example and not limitation, operating systems, application programs, data files, directory structures, computer-executable instructions, and the like.

Output components or devices, such as display device 302, may be coupled to computing device 301, typically via an interface such as a display adapter 311. Output device 302 may be a liquid crystal display (“LCD”). Other example output devices may include printers, audio outputs, voice outputs, cathode ray tube (“CRT”) displays, tactile devices or other sensory output mechanisms, or the like. Output devices may enable computing device 301 to interact with human operators or other machines, systems, computing environments, or the like. A user may interface with computing environment 300 via any number of different I/O devices 303 such as a touch pad, buttons, keyboard, mouse, joystick, game pad, data port, and the like. These and other I/O devices may be coupled to processor 307 via I/O interfaces 312 which may be coupled to system bus 308, and/or may be coupled by other interfaces and bus structures, such as a parallel port, game port, universal serial bus (“USB”), fire wire, infrared (“IR”) port, and the like.

Computing device 301 may operate in a networked environment via communications connections to one or more remote computing devices through one or more cellular networks, wireless networks, local area networks (“LAN”), wide area networks (“WAN”), storage area networks (“SAN”), the Internet, radio links, optical links and the like. Computing device 301 may be coupled to a network via network adapter 313 or the like, or, alternatively, via a modem, digital subscriber line (“DSL”) link, integrated services digital network (“ISDN”) link, Internet link, wireless link, or the like.

Communications connection 314, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Power source 390, such as a battery or a power supply, typically provides power for portions or all of computing environment 300. In the case of the computing environment 300 being a mobile device or portable device or the like, power source 390 may be a battery. Alternatively, in the case computing environment 300 is a desktop computer or server or the like, power source 390 may be a power supply designed to connect to an alternating current (“AC”) source, such as via a wall outlet.

Some mobile devices may not include many of the components described in connection with FIG. 3. For example, an electronic badge may be comprised of a coil of wire along with a simple processing unit 307 or the like, the coil configured to act as power source 390 when in proximity to a card reader device or the like. Such a coil may also be configure to act as an antenna coupled to the processing unit 307 or the like, the coil antenna capable of providing a form of communication between the electronic badge and the card reader device. Such communication may not involve networking, but may alternatively be general or special purpose communications via telemetry, point-to-point, RF, IR, audio, or other means. An electronic card may not include display 302, I/O device 303, or many of the other components described in connection with FIG. 3. Other mobile devices that may not include many of the components described in connection with FIG. 3, by way of example and not limitation, include electronic bracelets, electronic tags, implantable devices, and the like.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code, data, applications, programs, or the like maintained in an electronic device such as a ROM. The term “software” generally refers to executable instructions, code, data, applications, programs, or the like maintained in or on any form of computer-readable media. The term “computer-readable media” typically refers to system memory, storage devices and their associated media, and the like.

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

1. A file system comprising:
a Symbolic Link Conversion (“SCS”) System coupled to a file system, the file system coupled to a physical storage whereon a symbolic link is stored; and
a Network File System (“NFS”) Server Driver coupled to the file system, the NFS server driver operable to communicate with a computer via a protocol.

2. The file system of claim 1 wherein the file system stores data on the physical storage in New Technology File System (“NTFS”) format.

3. The file system of claim 1 wherein the symbolic link is in NFS format.

4. The file system of claim 3 wherein the protocol is a Server Message Block (“SMB”) protocol.

5. The file system of claim 4 wherein the SCS System translates the symbolic link into a format compatible with the SMB protocol.

6. The file system of claim 1 wherein the SCS System is implemented as a mini-filter of the file system.

7. The file system of claim 1 wherein the computer is coupled to the file system via a network connection.

8. A symbolic link conversion (“SCS”) system coupled to a file system wherein the SCS system translates a symbolic link retrieved from a physical storage by the file system responsive to a request from a caller.

9. The SCS system of claim 8 wherein the SCS system translates the symbolic link from a first format to a second format wherein the second format is compatible with the caller.

10. The SCS system of claim 8 wherein the request from the caller is made using a Server Message Block (“SMB”) protocol or an Application Programming Interface (“API”).

11. The SCS system of claim 9 wherein the first format is a Network File System (“NFS”) format.

12. The SCS system of claim 9 wherein the second format is a New Technology File System (“NTFS”) format.

13. A method for converting a symbolic link comprising:
reading a file responsive to a request from a caller;
determining if the file is a symbolic link file;
reading a symbolic link from the symbolic link file;
translating the symbolic link into a second format; and
returning the symbolic link in the second format.

14. The method of claim 13 further comprising:
determining if the caller is a Network File System (“NFS”) caller;
determining if the request is a create file request; and
checking file attributes.

15. The method of claim 13 further comprising:
allocating a REPARSE DATA BUFFER; and
filling in portions of the REPARSE DATA BUFFER with data of the symbolic link in the second format.

16. The method of claim 13 wherein the symbolic link is a New Technology File System (“NTFS”) symbolic link.

17. The method of claim 16 wherein the symbolic link is not translated if the caller is an SMB caller or a local caller.

18. The method of claim 13 wherein the symbolic link is a Network File System (“NFS”) symbolic link.

19. The method of claim 18 wherein the symbolic link is not translated if the caller is an NFS caller.

20. The method of claim 13 embodied as computer-executable instructions stored on a computer-readable medium.
